(19) United States
(12) Patent Application Publication
(10) Pub. No.: US 2020/0234234 A1
(43) Pub. Date: Jul. 23, 2020

(54) INFORMATION PROCESSING DEVICE

(71) Applicant: Maruichi Warehouse Co., Ltd., Yamanashi (JP)

(72) Inventor: Makoto HORIUCHI, Kofu-shi (JP)

(73) Assignee: Maruichi Warehouse Co., Ltd., Yamanashi (JP)

(21) Appl. No.: 16/486,293

(22) PCT Filed: Feb. 27, 2018
(86) PCT No.: PCT/JP2018/007356

§ 371 Date: Aug. 15, 2019

(30) Foreign Application Priority Data
Feb. 27, 2017 (JP) 2017-035470

(51) Int. Cl. G06Q 10/08

(52) U.S. Cl. CPC G06Q 10/0833; G06Q 10/0838; G06Q 10/0835

(57) ABSTRACT

When a moving body is to receive a new, additional article for transport, the present invention makes it possible for the new, additional article to be received for transport with consideration given not only to restrictions on the weight that can be transported by the moving body but also to restrictions on driver compliance. According to the present invention, a present-situation-information acquisition unit 71 acquires: respective characteristic values for one or more articles that include a prescribed article and are being transported by a moving body; and present transport conditions that include respective transport routes for the one or more articles. An additional-conditions acquisition unit 72 acquires: a characteristic value for an additional article; and additional transport conditions that include a transport route for the additional article. A conditions determination unit 73 determines whether the additional transport conditions can be added to the present transport conditions within the bounds of prescribed restrictions on compliance and restrictions on the weight that can be transported. When it has been determined that the additional transport conditions can be added to the present transport conditions, determination-results notification unit 74 so notifies a person that produced the additional transport conditions.

### TECHNICAL FIELD

The present invention relates to an information processing device.

### BACKGROUND ART

In the past, a technique that provides a distribution management system that can check the flow of a package in a timely and accurate manner, is easy to construct, and is inexpensive has been known (see, for example, Patent Document 1). Specifically, a delivery business having a delivery route configured with a plurality of delivery destinations as a unit is positioned as a job (unit job), job data corresponding to the job is generated, the job data, a mobile phone, and a moving body communication device such as a car phone are allocated to each delivery vehicle. Further, a technique in which, as delivery to each delivery destination is completed, a delivery completion report is transmitted to a mail server, the job data is reproduced by a distribution management program on the basis of this, and a sender can easily view a delivery situation that changes every moment via the Internet is known.

Patent Document 1: Japanese Unexamined Patent Application, Publication No. 2000-268101

### DISCLOSURE OF THE INVENTION

### Problems to be Solved by the Invention

However, in the related art including the technique disclosed in Patent Document 1, although the sender can check the article delivery situation which changes every moment, it is difficult for a moving body (for example, a truck) that transports articles to receive a new additional transport of an article. Specifically, it is difficult for a moving body (for example, a truck) that transports articles to receive a new additional transport of the article with consideration given not only restrictions on a weight which can be transported by the moving body but also to restrictions on driver compliance when receiving a new additional transport of the article. In this regard, currently, it is required to establish a technique capable of enabling to receive a new additional transport of an article with consideration given not only restrictions on a weight which can be transported by the moving body but also to restrictions on driver compliance when a moving body is to receive a new additional transport of the article.

The present invention was made in light of the foregoing, and it is an object of the present invention to provide a technique capable of enabling to receive a new additional transport of an article with consideration given not only to restrictions on a weight which can be transported by the moving body but also to restrictions on driver compliance when a moving body is to receive a new additional transport of the article.

### Means for Solving the Problems

In order to achieve the above objects, an information processing device of one aspect of the present invention is an information processing device in which a moving body on which restrictions on a transportable weight are imposed receives an additional transport of an article other than a predetermined article while moving the predetermined article from a point of departure to a point of arrival by driving of a driver on which restrictions on predetermined compliance are imposed, including:
present-situation-conditions acquisition section that acquires each of characteristic values of one or more articles being currently transported by the moving body including the predetermined article and present transport conditions including a transport route of each of the one or more articles;
an additional-conditions acquisition section that acquires additional transport conditions including a characteristic value of an article to be added and a transport route of the article to be added;
a conditions determination section that determines whether or not the additional transport conditions is able to be added to the present transport conditions within bounds of the restrictions on the predetermined compliance and the restrictions on the transportable weight; and
a notification section that gives, when it is determined that the additional transport conditions is able to be added to the present transport conditions, a notification indicating the determination to a person presenting the additional transport conditions.

### Effects of the Invention

According to the present invention, it is possible to provide a technique capable of enabling to receive a new additional transport of an article with consideration gives not only to restrictions on a weight which can be transported by the moving body but also to restrictions on driver compliance when a moving body is to receive a new additional transport of the article.

### BRIEF DESCRIPTION OF THE DRAWINGS

FIG. 1 is a block diagram illustrating a configuration of an information processing system according to an embodiment of the present invention.

FIG. 2 is a block diagram illustrating a hardware configuration of a server in the information processing system of FIG. 1.

FIG. 3 is a functional block diagram illustrating a functional configuration for executing a conditions determination process among the functional configurations of the server of FIG. 2.

FIG. 4 is a diagram illustrating a specific example of conditions determination process executed by the server of FIG. 2.

FIG. 5 is a flowchart for describing the conditions determination process executed by the server of FIG. 3.

FIG. 6 is a diagram illustrating a specific example of the conditions determination process executed by a server 1 of FIG. 2, and illustrates an example different from that of FIG. 4.

FIG. 7 is a diagram illustrating an example of a screen for inputting “present transport conditions” which is displayed on a driver terminal.

FIG. 8 is a diagram illustrating an example of a screen displayed on a driver terminal as detailed information of a transport route of each additional transport condition.

FIG. 9 is a diagram illustrating an example of a screen displayed on a driver terminal 2 as detailed information of a transport route of each additional transport condition, and is a diagram different from FIG. 8.

### PREFERRED MODE FOR CARRYING OUT THE INVENTION

Hereinafter, an embodiment of the present invention will be described with reference to the appended drawings.

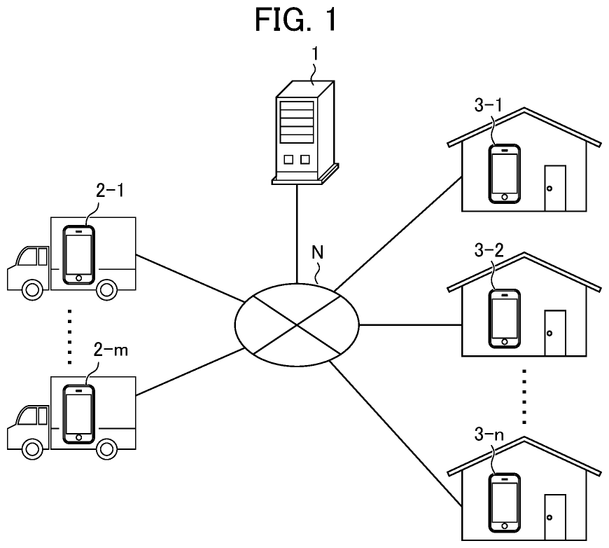

FIG. 1 is a block diagram illustrating a configuration of an information processing system according to an embodiment of the present invention.

The information processing system illustrated in FIG. 1 includes a server 1, driver terminals 2-1 to 2-m used by respective drivers driving trucks of m persons (m is an arbitrary integer value of 1 or more), user terminals 3-1 to 3-n used by n users (n is an arbitrary integer value of 1 or more) are connected to one another via a predetermined network N such as the Internet.

The server 1 is described as a single server for convenience of description, but the number of servers 1 is riot particularly limited and may be two or more. Also, when there is no particular need to distinguish each of the driver terminals 2-1 to 2-m, they are referred to collectively as a “driver terminal 2”. Similarly, when there is no particular need to distinguish each of the user terminals 3-1 to 3-n, they are referred to collectively as a “user terminal 3”.

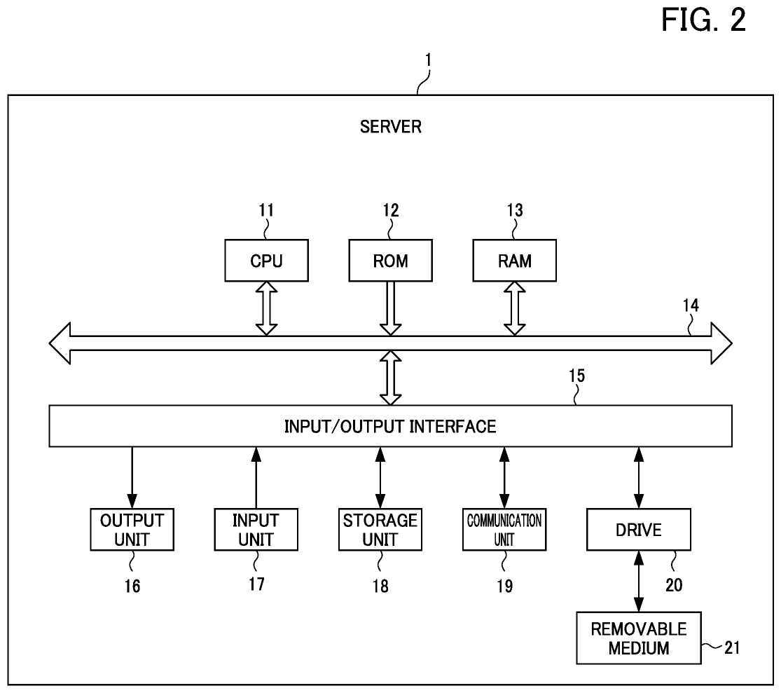

FIG. 2 is a block diagram illustrating a hardware configuration of the server 1 of an embodiment of the present invention in the information processing system in FIG. 1.

The server 1 includes a central processing unit (CPU) 11, a read only memory (ROM) 12, a random access memory (RAM) 13, a bus 14, an input/output interface 15, an output unit 16, an input unit 17, a storage unit 18, a communication unit 19, and a drive 20.

The CPU 11 executes various types of processes in accordance with a program recorded in the ROM 12 or a program loaded from the storage unit 18 to the RAM 13. The RAM 13 also stores data necessary for the CPU 11 to execute various types of processes.

The CPU 11, the ROM 12, and the RAM 13 are connected to one another via the bus 14. The input/output interface 15 is also connected to the bus 14. The output unit 16, the input unit 17, the storage unit 18, the communication unit 19, and the drive 20 are connected to the input/output interface 15.

The output unit 16 includes various types of liquid crystal displays and outputs various types of information. The input unit 17 includes various types of hardware and receives various types of information. The storage unit 18 includes a hard disk, a dynamic random access memory (DRAM), or the like, and stores various types of data. The communication unit 19 controls communication performed with other devices (for example, the driver terminal 2, the user terminal 3, or the like in FIG. 1) via the network N including the Internet.

The drive 20 is installed if necessary. A removable medium 21 including a magnetic disk, an optical disk, magneto-optical disk, a semiconductor memory, or the like is appropriately mounted on the drive 20. A program read from the removable medium 21 by the drive 20 is installed in the storage unit 18 if necessary. The removable medium 21 can also store various types of data stored in the storage unit 18, similarly to the storage unit 18.

Configurations of the driver terminal 2 and the user terminal 3 are basically similar to the configuration of the server 1 except that the driver terminal 2 has a global positioning system (GPS) function, and thus description thereof is omitted here.

Various types of processes to be described below are realized by cooperation of various types of hardware and software of the server 1, the driver terminal 2, and the user terminal 3 of FIG. 2.

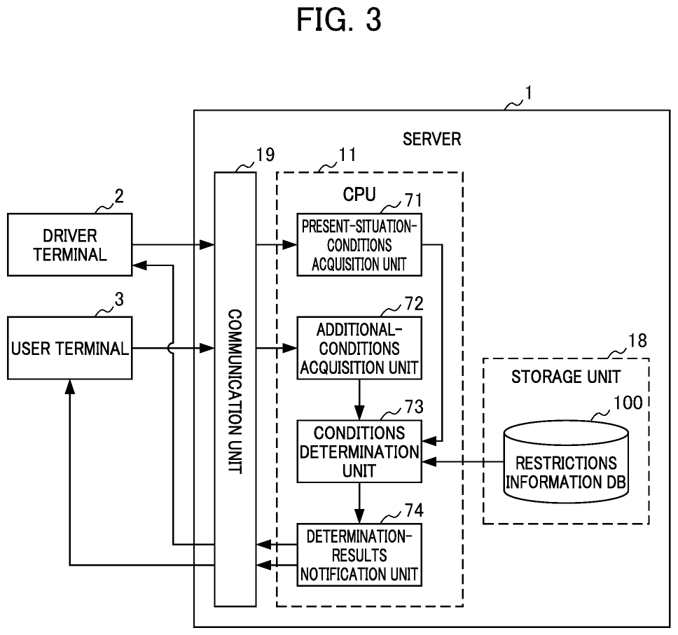

FIG. 3 is a functional block diagram illustrating functional configurations of the server 1, the driver terminal and the user terminal 3 in FIG. 2. Here, a “conditions determination process” refers to a series of processes of acquiring present transport conditions and additional transport conditions, determining whether or not the additional transport conditions can be added to the present transport conditions on the basis of the present transport conditions, the additional transport conditions, and information on restrictions, and notifying determination results.

In the CPU 11 of the server 1, as illustrated in FIG. 3, a present-situation-conditions acquisition unit 71, an additional-conditions acquisition unit 72, a conditions determination unit 73, and a determination-results notification unit 74 function. Further, a restrictions information DB 100 is disposed in one area of the storage unit 18.

The present-situation-conditions acquisition unit 71 of the server 1 acquires the present transport conditions transmitted from the driver terminal 2 via a notification unit 19. In other words, the present transport conditions are conditions including information on the number of pallets loaded with articles currently transported by a truck, information on an article transport route, and information on a deadline. The present-situation-conditions acquisition unit 71 provides the acquired present transport conditions to the conditions determination unit 73.

The additional-conditions acquisition unit 72 acquires the additional transport conditions transmitted from the user terminal 3 via the notification unit 19. In other words, the additional transport conditions are conditions including information on the number of pallets loaded with articles to be added to the truck and information on the transport route of the articles. The additional-conditions acquisition unit 72 provides the acquired additional transport conditions to the conditions determination unit 73.

Here, the restrictions information DB 100 holds information on restrictions on the driver compliance, information on restrictions on the number of pallets which can be transported by the truck, and information on restrictions on a deadline as “information on restrictions”. The compliance includes working conditions.

The conditions determination unit 73 acquires the present transport conditions provided from the present-situation-conditions acquisition unit 71 and the additional transport conditions provided from the additional-conditions acquisition unit 72. For example, the conditions determination unit 73 extracts the information on restrictions stored in the restrictions information DB 100. Then, the conditions determination unit 73 determines whether or not the additional transport conditions can be added to the present transport conditions on the basis of the present transport conditions provided from the present-situation-conditions acquisition unit 71, the additional transport conditions provided from the additional-conditions acquisition unit 72, and the information on restrictions extracted from the restrictions information DB 100. The conditions determination unit 73 provides determination results to the determination-results notification unit 74.

The determination-results notification unit 74 notifies the driver terminal 2 and the user terminal of the determination results indicating that the additional transport conditions can be added to the present transport conditions provided from the conditions determination unit 73 via the notification unit 19.

Accordingly, the truck can receive a new additional transport of an article with consideration given not only to the restrictions on the weight which can be transported by the truck but also to the restriction on the driver compliance when receiving a new additional transport of an article. As a result, it is possible to provide a technology that enables the truck (moving body) to receive a new additional transport of an article.

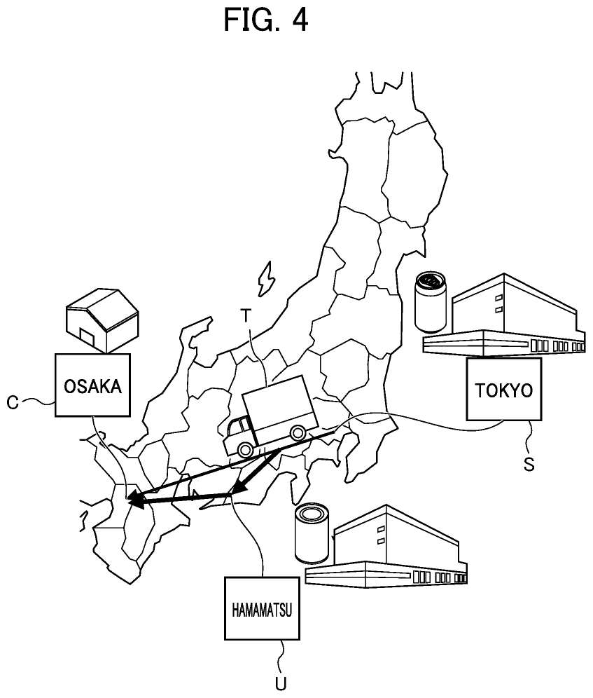

Here, a specific example of the conditions determination process executed by the server 1 of FIG. 2 wild be described with reference to FIG. 4. FIG. 4 is a diagram illustrating a specific example of the conditions determination process executed by the server 1 of FIG. 2.

For example, as illustrated in FIG. 4, a truck T is loaded with 7 pallets loaded with articles (for example, canned coffees) from a sender S in Tokyo, leaves the sender S at 9:00 A.M. on January 23rd, and is transporting the article toward a customer C located in Osaka. A deadline of the article for the customer C is 5:00 P.M. on January 24th. Here, the restriction on the number of pallets which can be transported by the truck T is 10, and working hours per day of the driver who drives the truck T is set to 8 hours (for example, from 9:00 A.M. on January 23rd to 5:00 P.M. on the same day) as the restrictions on the compliance. In other words, since the restriction on the number of pallets which can be transported by the truck T is 10, the truck T which is currently loaded with 7 pallet can transport 3 pallets additionally. In this regard, the driver driving the truck transmits the “present transport conditions” to the server 1 using the driver terminal 2. Specifically, the driver transmits information on the number of pallets CO currently transported by the truck T, information on the transport route of the articles (from the sender S to the customer C), and information on the deadline (5:00 P.M. on January 24th) of the articles to the customer C to the server 1 as the “present transport conditions”. Here, a time required to transport from the sender S to the customer C at the shortest distance is about 5 hours. That is, if it leaves the sender S at 9:00 A.M. on January 23rd, an estimated arrival Lime of the truck T at the customer C is 2:00 P.M. on January 23rd.

A user U in Hamamatsu transmits the “additional transport conditions” to the server 1 using the user terminal 3 when the user desires to additionally transport 3 pallets loaded with articles (for example, canned food). Specifically, the user U transmits information on the number of pallets (3) loaded with articles to be added to the truck T and information on the transport route of the article (from the user U to the customer C) to the server 1 as the “additional transport conditions”. Here, the time required for transporting from the sender S to the customer C via the user U at the shortest distance is about 7 hours. That is, if it leaves the sender S at 9:00 A.M. on January 23rd, an estimated arrival time of the truck T at the customer C is 4:00 P.M. on January 23rd.

As the restrictions on compliance, the working hours of the driver is 8 hours, while the time required for transporting from the sender S to the customer C via the user U is about 7 hours. In other words, the travel time is within the bound of the restrictions on the compliance related to the working hours of the driver. Also, for example, the restrictions on the number of pallets which can be transported by the truck T is 10, whereas the number of pallets currently being transported by the truck T is 7, and the number of Pallets to be added from the user U is 3. That is, it is within the bound of the restrictions on the number of pallets which can be transported by the truck T. Also, for example, the deadline of the articles to the customer C is the deadline of the articles is 5:00 P.M. on January 24th. In contrast, if it leaves the sender S at 9:00 A.M. on January 23rd, an estimated arrival time of the truck T at the customer C is 4:00 P.M. on January 23rd. That is, it is within the bound of the restrictions on the deadline of the articles to the customer C. Then, the server 1 determines that the additional transport conditions can be added to the present transport conditions, and notifies the driver terminal 2 and the user terminal 3 of the determination results. The driver driving the truck T checks the determination results notified from the server 1 via the driver terminal 2. The truck I then stops at the user U and transports 3 pallets loaded. with articles (for example, canned food) from the user U to the customer C together with 7 pallets loaded from the sender S.

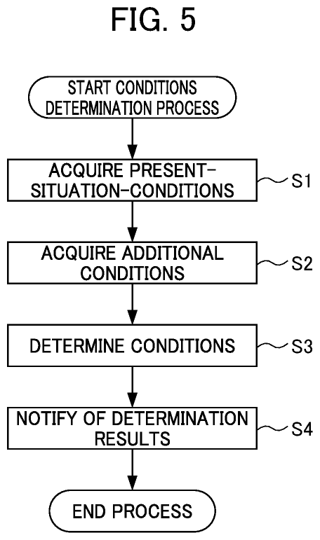

The example of the functional configuration for executing the conditions determination process among the functional configurations of the server 1 of FIG. 2 has been described above with reference to FIGS. 3 and 4. Next, the flow of the conditions determination process executed by the server 1 in FIG. 4 will be described with reference to FIG. 5.

FIG. 5 is a flowchart describing the conditions determination process executed by the server 1 of FIG. 3.

In step S1, the present situation-conditions acquisition unit 71 acquires the present transport conditions transmitted from the driver terminal 2 via the notification unit 19.

In step S2, the additional-conditions acquisition unit 72 acquires the additional transport conditions transmitted from the user terminal 3 via the notification unit 19.

In step S3, the conditions determination unit 73 acquires the present transport conditions acquired in step S1 and the additional transport conditions acquired in step S2. The conditions determination unit 73 extracts the information on restrictions stored in the restrictions information DB 100. Then, the conditions determination unit 73 determines whether or not the additional transport conditions can be added to the present transport conditions on the basis of the present transport conditions acquired in step S1, the additional transport conditions acquired in step S2, and the information on restrictions extracted from the restrictions information DB 100.

In step S4, the determination-results notification unit 74 notifies the driver terminal 2 and the user terminal 3 of the determination results indicating that the additional transport conditions can be added to the present transport conditions determined in step S3 via the notification unit 19.

Accordingly, it is possible to provide a technique capable of enabling to receive a new additional transport of an article with consideration given not only to restrictions on a weight which can be transported by the moving body but also to restrictions on driver compliance when a moving body is to receive a new additional transport of the article.

Although the embodiment, of the information processing device of the present invention has been described above, the present invention is not limited to the present embodiment described above. Further, the effects described in the present embodiment are merely a list of the most preferable effects resulting from the present invention, and the effects of the present invention are not limited to those described in the present embodiment.

For example, the above embodiment, the number of pallets is employed as the characteristic value of the article, but the present invention is not particularly limited thereto. Other article characteristic values may be used.

Also, for example, in the above embodiment, the information on the number of pallets loaded with articles currently being transported by the truck, the information on the transport route of the articles, and the information on the deadlines are employed as the “present transport conditions,” but the present invention is not particularly limited thereto. Other information may be adopted.

Also, for example, in the above-described embodiment, the information on the number of pallets loaded with articles to be added to the truck and the information on the transport route of the articles are employed as the “additional transport conditions,” but the present invention is not particularly limited thereto. Other information may be adopted.

Also, for example, in the above-described embodiment, the information on the restrictions on the driver compliance, the information on the restrictions on the number of pallets which can be transported by the truck, and the information on the restrictions on the deadline are employed as the information on restrictions, but the present invention is not particularly limited thereto. Other information may be employed.

Also, for example, in the above-described embodiment, it is determined whether or not the additional transport conditions can be added to the present transport conditions on the basis of one additional transport condition presented by one user, but the present invention is not particularly limited thereto. It may be determined whether or not N (N is any integer value of M or less) additional transport conditions can be added to the present transport conditions on the basis of M (M is any integer value of 2 or more) or more additional transport conditions presented by a plurality of users.

Further, when the conditions determination unit 73 of the server 1 determines that two or more additional transport conditions can be added to the present transport conditions on the basis of the M or more additional transport conditions presented by a plural city of users, one additional transport conditions may be determined. Specifically, a priority may be determined on the basis of a certain condition, and one additional transport condition among two or more additional transport conditions may be determined in accordance with the priority. Here, the “certain condition” section, for example, a condition that a cost related to transport is high, and a transport time is short.

Further, the determined additional transport conditions are not limited to one additional transport condition, and two or more additional transport conditions may be determined.

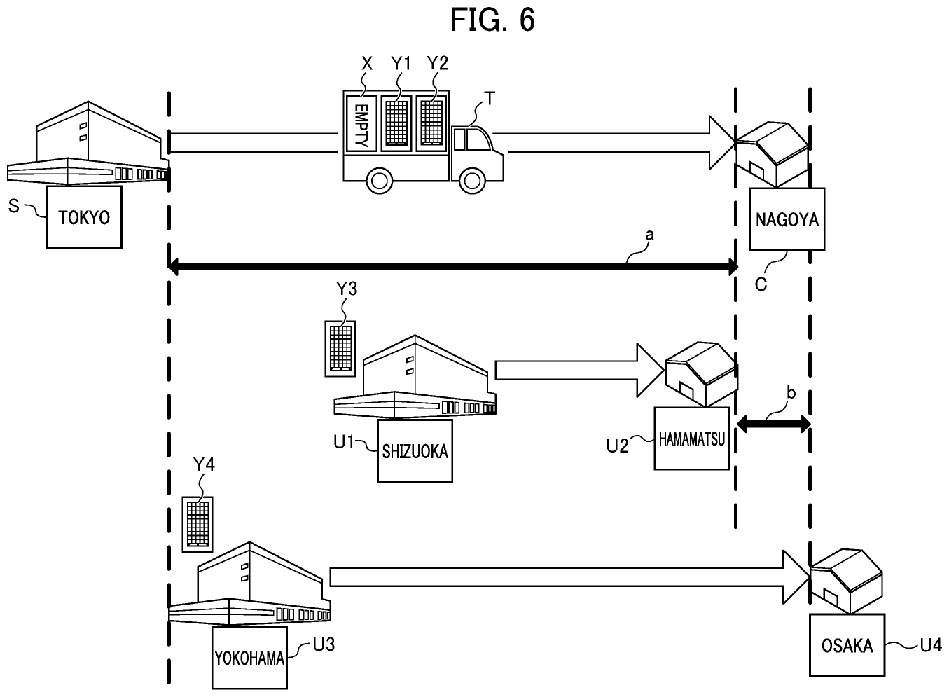

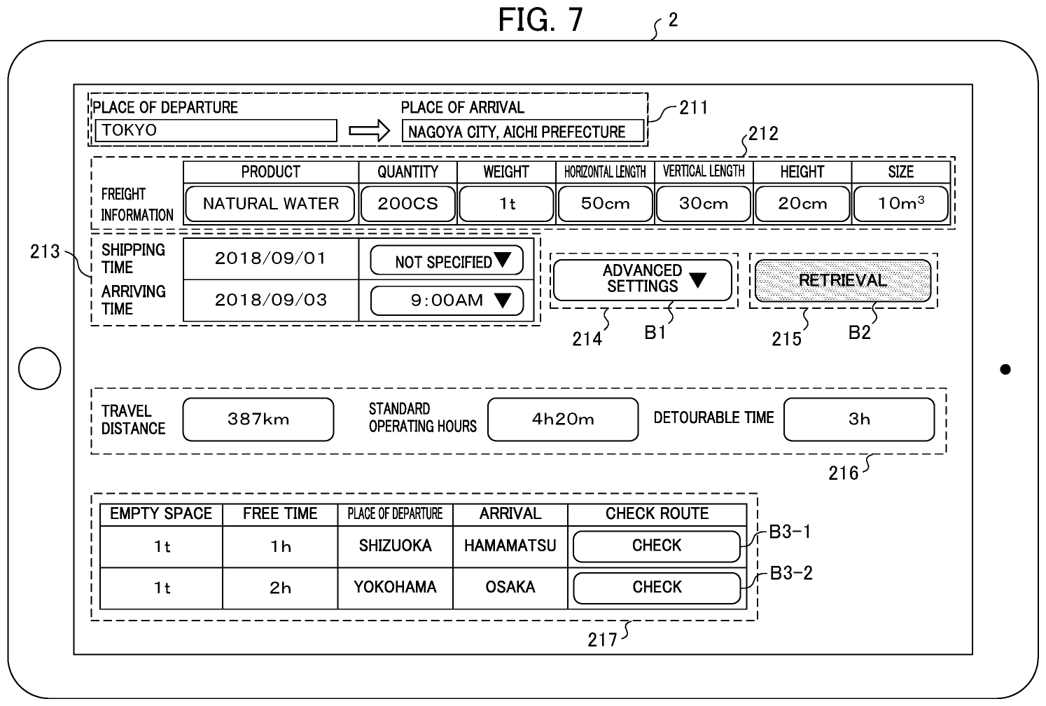

In the above-described conditions determination. process, the driver driving the truck transmits the “present transport conditions” to the server 1 using the driver terminal 2. At this time, a specific method of transmitting the “present transport conditions” from the driver terminal 2 to the server 1 is not particularly limited, but a method using the screen illustrated in FIG. 7 may be employed when transmitting the “present transport conditions”. Hereinafter, specific example for transmitting the “present transport conditions” to the server 1 using the driver terminal 2 will be described with reference to FIG. 6 to FIG. 9.

FIG. 6 is a diagram illustrating a specific example of the conditions determination process executed by the server 1 in FIG. 2, and illustrates an example different from that of FIG. 4. In the example of FIG. 6, a case in which the truck T is loaded with 2 pallets Y1 and Y2 from the sender S located in Tokyo and transports them toward the customer C located in Nagoya is assumed.

As illustrated in FIG. 6, the truck has an empty space X in a state in which the pallets Y1 and Y2 are loaded. For the driver who drives the truck the working hours per day are set as the restrictions on the compliance. For this reason, the truck can add a pallet to the empty space X and transport it within the working hours of the driver. In other words, if a condition that the sum of the driver's driving time and the freight loading/unloading time falls within the driver's daily working hours, and it arrives before the deadline for the customer C is satisfied, the truck T can transport it through a detour. In other words, if the truck has the empty space X and can clear the time restrictions, the freight can be transported using the empty space X. For example, the truck T can transport a pallet Y3 in empty space X in a section from a user U1 in Shizuoka to a user U2 in Hamamatsu within a range of a section a. Alternatively, for example, the truck T loads a pallet Y4 into the empty space X and transport it in a section (a+b) from a user U3 in Yokohama to a user U4 in Osaka as transport in which a section b outside the range of the section a is added. As described above, the empty space X of the truck T can be used effectively. Among freights transported by the truck I, a freight which has been transported or is to be transported from the beginning (pallets T1 and T2 in the example of FIG. 6) is hereinafter referred to as an “initial freight,” and a freight to be additionally transported are referred to as an “additional freight”.

The driver terminal 2 transmits the “present transport conditions” to the server I on the basis of an operation of the driver driving the truck T. As this operation, the driver can input the “present transport conditions” using the screen illustrated in FIG. 7. FIG. 7 is a diagram illustrating an example of the screen for inputting the “present transport conditions” displayed on the driver terminal 2.

Referring to FIG. 7, the screen of the driver terminal 2 is divided into display regions 211 to 217. Input areas for two items, that is, a place of departure and a place of arrival are disposed in the display region 211. The driver can freely input the place of departure and the place of arrival when transporting the initial freight in these two input areas. In the example of FIG. 7, “Tokyo” is input to the input area of the item of the place of departure. This indicates that the place of departure of the truck when transporting the initial freight is Tokyo. Further, “Nagoya City, Aichi Prefecture” is input to the input area of the item of the plane of arrival. This indicates that the place of arrival of the truck T that transports the initial freight is Nagoya City, Aichi Prefecture.

In the display region 212, input areas are disposed for seven items, that is, a product, a quantity, a weight, horizontal length, a vertical length, a height, and a size (volume) as items related to freight information. The driver can freely input a product name, a quantity, a weight, a horizontal length, a vertical length, a height, and a size (volume) of the freight to be transported to these seven input areas. In the example of FIG. 7, “natural water” is input to the input area of the item of the product. This indicates that the product name of the freight transported by the truck T is natural water. Further, “200 CS” is input to the input area of the item of the quantity. This indicates that the quantity of the freight transported by the truck is 200 CS. Also, “5 t” is input to the input area of the item of the weight. This indicates that the weight of the freight transported by the truck is 1 t (ton). Also, “50 cm” is input to the input area of the item of the horizontal length. This indicates that the horizontal length of the freight transported by the truck T is 50 cm (centimeter). Also, “30 cm” is input to the input area of the item of the vertical length. This indicates that the vertical length of the freight transported by the truck T is 30 cm. Also, “20 cm” is input to the input area of the item of the height. This indicates that the height of the freight transported by the truck T is 20 cm. Also, “10 m3” is input to the input area of the item of the size. This indicates that the volume of the freight transported by the truck T is 10 m3 (cubic meter).

In the display region 213, input areas are disposed for two items, that is, a shipping time and an arriving time. The driver of the truck T can freely input dates and time of shipping and arriving to these two input areas for the initial freight. In the example illustrated in FIG. 7, “2018/09/01” and “Not specified” are input to the input area of the item of the shipping time. This indicates that a shipping date of the initial freight is Sep. 1, 2018 and that a shipping time of the initial freight is not specified. Further, “2018/09/01” and “9:00” are input to the input area of the item of the arriving time. This indicates that the arriving date and time of the initial freight is 9 O'clock on Sep. 3, 2018.

A button B1 for performing advanced settings is disposed in the display region 214. The user can perform advanced settings by pressing this button B1. If the button B1 is pressed, a pop-up menu (not illustrating) for performing advanced settings can be displayed.

A button B2 for executing retrieval is disposed in the display region 215. If the button B2 is pressed, the server 1 calculates a travel distance, a standard operation time, and a detourable time of the truck T on the basis of the present transport conditions input to the respective input areas.

The travel distance, the standard operation time, and the detourable time of the truck T calculated by the server 1 are displayed in the display region 216. In the example of FIG. 7, “387 km” is displayed in a travel distance field. This indicates that a total distance traveled by the truck T in the initial freight transport is 387 km. Also, “4 h 20 m” is displayed in the standard operation time field. This indicates that a total time spent by the truck T for the initial freight transport is 4 hours and 20 minutes. Further, “3 h” is displayed in the detourable time field. This indicates that the total time that can be spent when transporting other freights (additional freights) by detouring the truck is 3 hours in the initial freight transport.

Content of additional transport conditions transmitted from the user terminal 3 to the server 1 is displayed in the display region 217. That is, among the one or more additional transport conditions transmitted from the user terminal 3 to the server 1, the additional transport condition that matches the present transport condons input to the driver terminal is displayed in the display region 217. The additional transport conditions displayed in the display region 217 are displayed in an auction format, for example, depending on a degree of matching. In the example of FIG. 7, the content of the two additional transport conditions is displayed. Specifically, an additional transport condition in which the empty space is “1 t”, the free time is “1 h,” the place of departure is “Shizuoka,” and the place of arrival is “Hamamatsu” is displayed in an upper part of the display region 217. This indicates that the time required for the truck T to stop by Shizuoka, load 1 t of additional freight to the empty space X, and transport it to Hamamatsu is 1 hour. An additional transport conditions in which the empty space is “1 t,” the free time is “2 h,” the place of departure is “Yokohama,” and the place of arrival is “Osaka” is displayed in a lower part of display region 217. This indicates that the time required for the truck T to stop by Yokohama, load 1 t of additional freight to the empty space X, and transport it to Osaka is 2 hours. Buttons B3-1 and B3-2 for causing the details of the transport route to be displayed on the map for the respective additional transport conditions are displayed in the display region 217. The driver of the truck T can check the content of the additional transport conditions displayed in the display region 217 and cause the details of the transport route to be displayed on the map if necessary. Accordingly, it is possible to check other freight transports using detours that can be realized under the restriction such as his/her working hours, a freight deadline, and a size of the empty space X of the truck T.

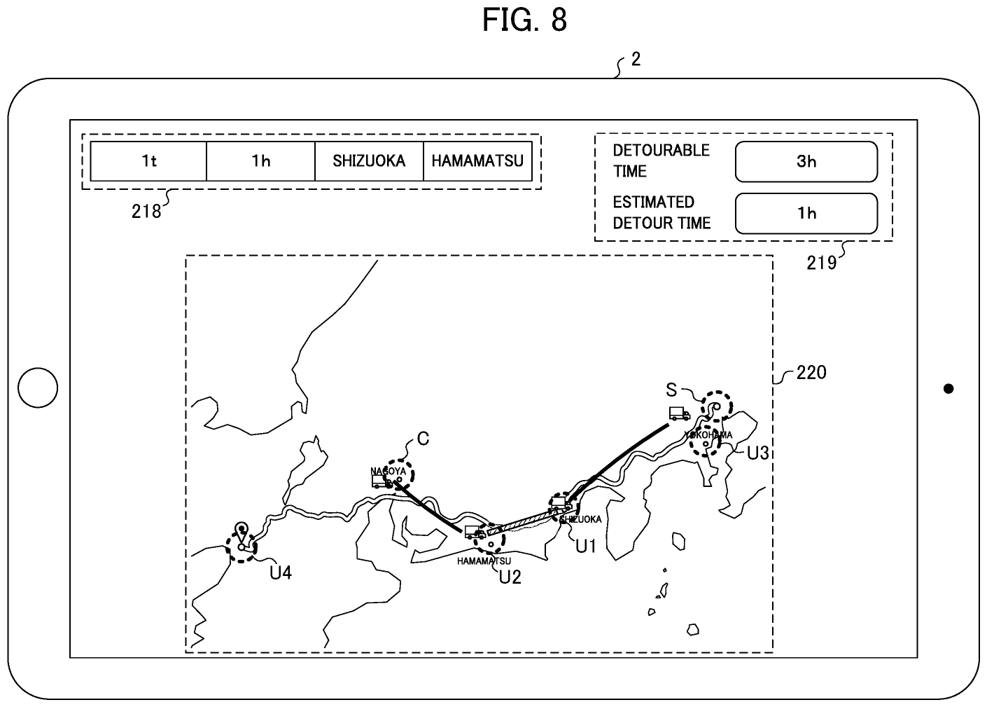

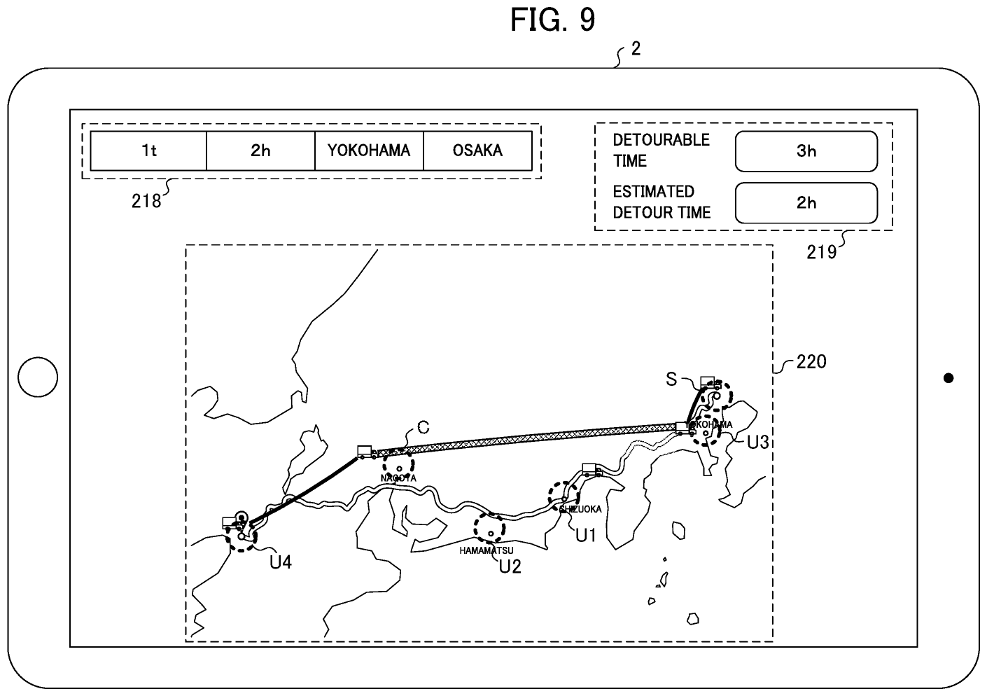

If the button B3-1 displayed in display region 217 is pressed, a screen illustrated in FIG. 8 is displayed. If the button B3-2 is pressed, a screen illustrated in FIG. 9 is displayed. FIGS. 8 and 9 are diagrams illustrating examples of the screen displayed on the driver terminal 2 as detailed information of the transport route of each additional transport condition.

Referring to FIG. 8, the screen of the driver terminal 2 is divided into display regions 218 to 220. Content corresponding to the content displayed in the display region 217 of FIG. 7 is displayed in the display regions 218 and 219. That is, the additional transport condition in which the empty space is “1 t,” the free time is “1 h,” the place of departure is “Shizuoka,” and the place of approval is “Hamamatsu” is displayed in the display region 218. A map illustrating the details of the transport route is displayed in the empty space display region 220.

Referring to FIG. 9, the screen of the driver terminal 2 is divided into display regions 218 to 220. Content corresponding to the content displayed in the display region 217 of FIG. 7 is displayed in the display regions 218 and 219. That is, the additional transport condition in which the empty space is “1 t,” the free time is “2 h,” the place of departure is “Yokohama,” and the place of approval is “Osaka” displayed in the display region 218. A map illustrating the details of the transport route is displayed in the display region 220.

As described above, by causing the present transport conditions transmitted from the driver of the truck T to the server 1 to match with the additional transport conditions transmitted from the user U to the server 1, the driver can easily check transport of the freight using a detour which is realizable under the time restrictions such as his/her working hours or the deadline and the physical restrictions on the empty space X of the truck X using the driver terminal 2. Also, the user U can receive the freight desired to be transmitted as sender at a low cost using the empty space X of the truck T.

Here, the user U desires transport of an additional freight. From the viewpoint of the truck T, the additional freight is sufficient if it is not the initial freight, and, for example, it may be a freight currently loaded on another truck. In other words, the driver terminal 2 of the driver of another truck (not illustrated) can also function as the user terminal and can transmit the additional transport conditions for transporting the freight from a predetermined. place (for example, a nearby warehouse, a parking lot, or the like) to the destination as long as it is possible to deliver the freight which is currently loaded to the predetermined place. Accordingly, the truck T can be also loaded with a freight of another truck as another freight and transport it. That is, the truck T can also easily transport a freight which is unable to be transported by him/herself (the driver of another truck) due to compliance reasons or physical reasons.

Moreover, the hardware configuration illustrated in FIG. 2 is merely an example for achieving the objects of the present invention, and the present invention is not particularly limited.

Further, the functional block diagram illustrated in FIG. 3 is merely an example, and the present invention is not particularly limited. That is, as long as the server 1 has the function capable of executing a series of processes described above as a whole, a functional block used to realize this function is not particularly limited to the example of FIG. 3.

Further, the location of the functional block is not limited to that illustrated in FIG. 3 but may be arbitrary. Further, one function block may be configured with hardware alone, software alone, or a combination thereof.

In a case in which the process of each functional block is executed by software, a program that configures the software is installed in a computer or the like from a network or a recording medium. The computer may be a computer which is incorporated in dedicated hardware. The computer may be a compute-capable of executing various types of functions by installing various types of programs such as a general-purpose smart phone or personal computer other than a server.

A recording medium containing such a program is not only configured with the removable medium 21 of FIG. 2 which is distributed separately from a main body of a device in order to provide the program to each user but also a recording medium which is provided to each user in a state in which it is installed in a main body of a device in advance. Examples of the removable medium 21 include a magnetic disk (including a floppy disk), an optical disk, and a magneto-optical disk. Examples of the optical disk include a compact disk-read only memory (CD-ROM), and a digital versatile disk (DVD). The magneto-optical disk includes a mini-disk (MD). Further, a recording medium provided to the user in a state in which it is installed in a device main body in advance is configured with, for example, the RPM 12 of FIG. 2 having a program recorded therein, a hard disk included in the storage unit 18 of FIG. 2, or the like.

In the present specification, steps of describing the program to be recorded on the recording medium include not only, as a matter of course, processes which are executed chronologically according to its order but also processes which are executed in parallel or individually although not necessarily in chronological order. Further, in the present specification, the term “system” section an overall device including a plurality of devices or a plurality of section.

In summary, the information processing device to which the present invention is applied is sufficient if the present invention has the following configuration, and various embodiments may be taken. That is, the information processing device to which the present invention applies (for example, the server 1 in FIG. 1) is
an information processing device in which a moving body on which restrictions on a transportable weight are imposed receives an additional transport of an article other than a predetermined article while moving the predetermined article from a point of departure to a point of arrival by driving of a driver on which restrictions on predetermined compliance are imposed, including:
a present-situation-conditions acquisition section (for example, the present-situation-conditions acquisition unit 71 of FIG. 4) that acquires each of characteristic values of one or more articles being currently transported by the moving body including the predetermined article and present transport conditions including a transport route of each of the one or more articles;
an additional-conditions acquisition section (for example, the additional-conditions acquisition unit 72 of FIG. 4) that acquires additional transport conditions including a characteristic value of an article to be added and a transport route of the article to be added,
a conditions determination section (for example, the conditions determination unit 73 of FIG. 4) that determines whether or not the additional transport conditions is able to be added to the present transport conditions within a bound of the restrictions on the predetermined compliance and the restrictions on the transportable weight; and
a notification section. (for example, the determination-results notification unit 74 of FIG. 4) that gives, when determined that the additional transport conditions is able to be added to the present transport conditions, a notification indicating the determination to a person presenting the additional transport conditions.

Accordingly, the moving body can receive a new additional transport of an article with consideration given not only to the restrictions on the weight which can be transported by the moving body but also to the restriction on the driver compliance when the moving body receives a new additional transport of an article. As a result, it is possible to provide a technology that enables the moving body to receive a new additional transport of an article.

Further, in the information processing device, the conditions determination section may determine, on the basis of M (M is an arbitrary integer value of 2 or more) additional transport conditions presented by the person presenting a plurality of additional transport conditions, whether or not the additional transport conditions of N (N is an arbitrary integer value less than or equal to M) can be added to the present transport conditions. Accordingly, for example, it is possible to determine whether or not two additional transport conditions can be added to the present transport conditions on the basis of four additional transport conditions. As a result, it is possible to provide a technology that enables the moving body to receive one or more new additional articles for transport.

Further, in the information processing device, The conditions determination section may determine a priority on the basis of a certain condition when it is determined that the two or more additional transport conditions can be added to the present transport conditions on the basis of the N or more additional transport conditions presented by the person presenting the plurality of additional transport conditions and determine one or more additional transport conditions among the two or more additional transport conditions in accordance with the priority. Accordingly, it is possible to determine one additional transport condition in accordance with the priority on the basis of a certain condition among the two or more additional transport conditions. As a result, it is possible to provide a technology that determines new additional transport of an article by the moving body in an auction format.

### EXPLANATION OF REFERENCE NUMERALS

1: SERVER, 2: DRIVER TERMINAL, 3: USER TERMINAL, 11: CPU, 71: PRESENT-SITUATION-INFORMATION ACQUISITION UNIT, 72: ADDITIONAL-CONDITIONS ACQUISITION UNIT, 73: CONDITIONS DETERMINATION UNIT, 74: DETERMINATION-RESULTS NOTIFICATION UNIT, 100: RESTRICTIONS INFORMATION DR

1. An information processing device in which a moving body on which restrictions on a transportable weight are imposed receives an additional transport of an article other than a predetermined article while moving the predetermined article from a point of departure to a point of arrival by driving of a driver on which restrictions on predetermined compliance are imposed, comprising:
a present-situation-conditions acquisition section that acquires each of characteristic values of one or more articles being currently transported by the moving body including the predetermined article and present transport conditions including a transport route of each of the one or more articles;
an additional-conditions acquisition section that acquires additional transport conditions including a characteristic value of an article to be added and a transport route of the article to be added;
a conditions determination section that determines whether or not the additional transport conditions is able to be added to the present transport conditions within a bound of the restrictions on the predetermined compliance and the restrictions on the transportable weight; and
a notification section that gives, when it is determined that the additional transport conditions is able to be added to the present transport conditions, a notification indicating the determination to a person presenting the additional transport conditions.

2. The information processing device according to claim 1, wherein the conditions determination section determines, on the basis of M (M is an arbitrary integer value of 2 or more) or more additional transport conditions presented by the person presenting a plurality of the additional transport conditions, whether or not the additional transport conditions of N (an N is an arbitrary integer value less than or equal to M) can be added to the present transport conditions.

3. The information processing device according to claim 1, wherein the conditions determination section determines a priority on the basis of a certain condition when it is determined that two or more additional transport conditions can be added to the present transport conditions on the basis of the M or more additional transport conditions presented by the person presenting the plurality of additional transport conditions and determines 1 additional transport conditions among the two or more additional transport conditions in accordance with the priority.
